(19) United States
(12) Patent Application Publication
(10) Pub. No.: US 2026/0200457 A1
(43) Pub. Date: Jul. 16, 2026

(54) VEHICLE CONTROL DEVICE AND VEHICLE CONTROL METHOD

(71) Applicant: TOYOTA JIDOSHA KABUSHIKI KAISHA, Toyota-shi (JP)

(72) Inventor: Takashi SAITO, Fuji-shi (JP)

(73) Assignee: TOYOTA JIDOSHA KABUSHIKI KAISHA, Toyota-shi (JP)

(21) Appl. No.: 19/391,422

(22) Filed: Nov. 17, 2025

(30) Foreign Application Priority Data
Jan. 14, 2025 (JP) 2025-004794

(51) Int. Cl. B60W 10/22; A63F 13/57; A63F 13/803; B60W 30/182

(52) U.S. Cl. CPC B60W 10/22; A63F 13/57; A63F 13/803; B60W 30/182; B60W 2510/225

(57) ABSTRACT

A vehicle control device comprises: an acquirer that acquires play information of a game played by an occupant of a vehicle; and a controller that controls a variable damping force absorber provided between a wheel and a vehicle body. The controller is capable of setting the variable damping force absorber to a first mode in which the magnitude of damping force generated in response to input is set, and to a second mode in which the damping force generated in response to the input is smaller than the first mode. The controller sets the variable damping force absorber to one of the first mode and the second mode according to an acquired game playing state.

### REFERENCE TO RELATED APPLICATIONS

This application is based upon and claims the benefit of priority from the prior Japanese Patent Application No. 2025-004794 filed on Jan. 14, 2025, the entire contents of which are incorporated herein by reference.

### BACKGROUND

### 1. Technical Field

This disclosure relates to technology for controlling a variable damping force absorber while the vehicle is stopped.

### 2. Background Information

JP 2021-113046 discloses an active suspension system that is installed between the vehicle wheels and the vehicle body, in series or parallel with the air suspension. The active suspension system is used to induce specific motions in the vehicle when playing video games. These motions are induced in response to pre-recorded motion tracking associated with audio or video recordings, or in response to commands given by the video game player in the vehicle using controller inputs.

In the technology disclosed in JP 2021-113046, if the vehicle body shakes easily, the operability of games played in the vehicle may deteriorate.

### SUMMARY

The purpose of the present disclosure is to provide a technology that enables setting the ease of shaking the vehicle body according to the information of playing games executed in the vehicle.

A vehicle control device according to one embodiment comprises: an acquirer that acquires play information of a game played by an occupant of a vehicle; and a controller that controls a variable damping force absorber provided between a wheel and a vehicle body. The controller is capable of setting the variable damping force absorber to a first mode in which the magnitude of damping force generated in response to input is set, and to a second mode in which the damping force generated in response to the input is smaller than the first mode. The controller sets the variable damping force absorber to one of the first mode and the second mode according to an acquired game playing state.

Another embodiment is a vehicle control method comprising: acquiring play information of a game played by an occupant of the vehicle; and controlling a variable damping force absorber provided between a wheel and a vehicle body. The variable damping force absorber is set to a first mode in which the magnitude of damping force generated in response to input is set, or to a second mode in which the damping force generated in response to the input is smaller than the first mode. In the controlling, the variable damping force absorber is set to one of the first mode and the second mode according to an acquired game playing state.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 shows the functional configuration of the example vehicle control system.

FIG. 2 is a diagram of a vehicle equipped with an active stabilizer system and variable damping force absorber.

FIG. 3 illustrates the setting mode of the variable damping force absorber.

FIG. 4 is a flowchart of the example vehicle control method.

### DETAILED DESCRIPTION

The invention will now be described by reference to the preferred embodiments. This does not intend to limit the scope of the present invention, but to exemplify the invention.

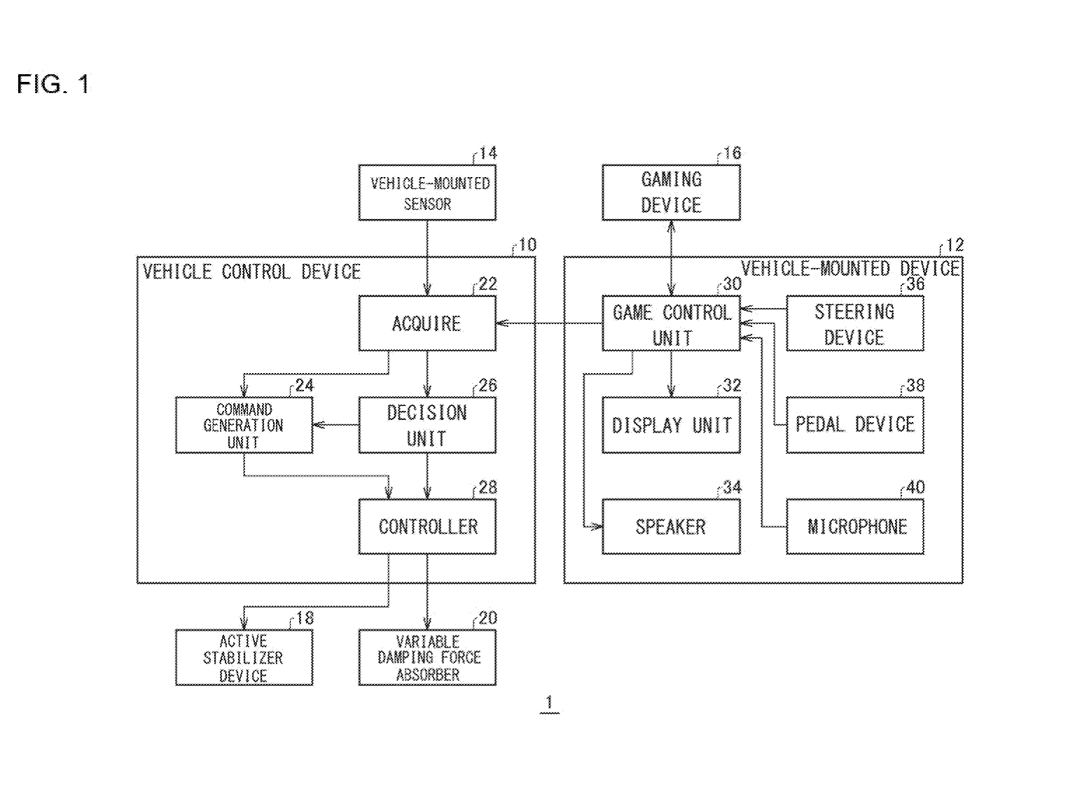

FIG. 1 shows the functional configuration of the example vehicle control system 1. In FIG. 1, each element described as a functional block that performs various processes can be composed of circuit blocks, memory, and other LSI in terms of hardware, and in terms of software, they are realized by programs, etc. loaded into memory. Therefore, it is understood by those skilled in the art that these functional blocks can be realized in various ways by hardware alone, software alone, or a combination thereof, and are not limited to any one.

Vehicle control system 1 is equipped with a vehicle control device 10, an vehicle-mounted device 12, an vehicle-mounted sensor 14, a gaming device 16, an active stabilizer device 18, and a variable damping force absorber 20. The vehicle control system 1 may be provided in a vehicle with an automatic driving function that can drive autonomously.

The vehicle control system 1 allows an occupant to play a game in the vehicle using the in-vehicle device 12. While the occupants are playing the game, the vehicle is stationary. The vehicle control system 10 controls the active stabilizer device 18 and the variable damping force absorber 20 according to the game playing state. This can provide the occupants with an environment conducive to game play by not shaking the vehicle, or can bring a sense of realism to the occupants by shaking the vehicle.

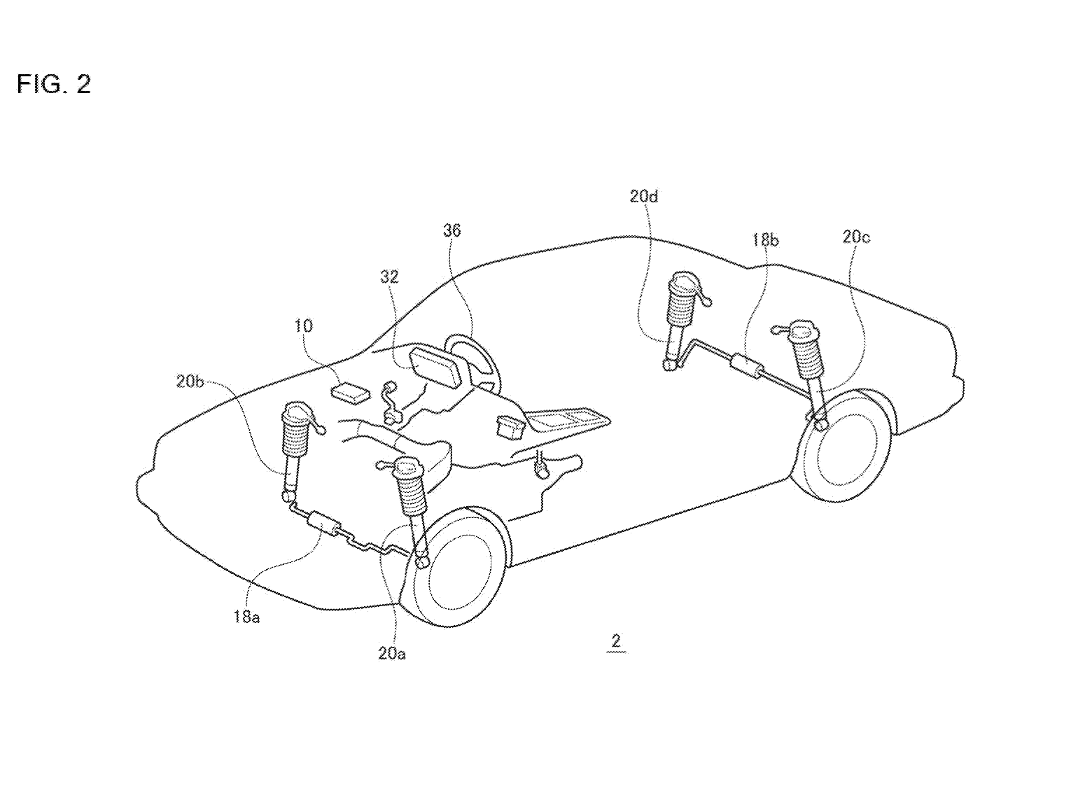

FIG. 2 is a diagram of a vehicle 2 equipped with an active stabilizer device 18 and a variable damping force absorber 20. The variable damping force absorber 20 is positioned between the wheels and the vehicle body and generates damping force for inputs from the wheels and the vehicle body. The variable damping force absorber 20 has a first variable damping force absorber 20a located on the left front wheel, a second variable damping force absorber 20b located on the right front wheel, a third variable damping force absorber 20c located on the left rear wheel, and a fourth variable damping force absorber 20d located on the right rear wheel.

The variable damping force absorber 20 has a cylinder connected to the wheel side and a piston connected to the vehicle body side. The variable damping force absorber 20 is located inside the coil spring. An iris mechanism is assembled to the piston. The diaphragm mechanism switches the opening degree of the connecting passageway that connects the upper and lower chambers of the cylinder in multiple stages by operation of an actuator controlled by the vehicle control device 10. When the opening degree of the connecting passageway is increased according to the switching stages, the damping force generated by the variable damping force absorber 20 is set to be relatively small. On the other hand, when the opening degree of the connecting passage becomes smaller, the damping force generated by the variable damping force absorber 20 is set to the side where the damping force becomes relatively larger.

The active stabilizer device 18 has a first active stabilizer device 18a disposed on the front wheel side and a second active stabilizer device 18b disposed on the rear wheel side. The active stabilizer devices 18 are connected at both ends to the left and right wheels, e.g., lower arms. The active stabilizer device 18 may be provided only on the front wheel side.

The active stabilizer device 18 has a right stabilizer bar, a left stabilizer bar, and an electric actuator that connects the right stabilizer bar and the left stabilizer bar for relative rotation. The vehicle control device 10 can drive the electric actuator to rotate the right stabilizer bar and the left stabilizer bar relative to each other to apply roll direction force to the vehicle body. The active stabilizer device 18 is used to control the roll direction movement of the vehicle body, but in the example, it is used to sway the vehicle body in the roll direction. The active stabilizer device 18 constitutes a vehicle behavior control device capable of rocking the vehicle body.

Return to FIG. 1. The vehicle-mounted sensors 14 include sensors that detect the amount of drive of the active stabilizer device 18, sensors that detect the opening degree of the variable damping force absorber 20, and sensors that detect the stopping of the vehicle. The on-board sensors 14 send the detection results to the vehicle control device 10.

The gaming device 16 is an external device that is carried in the vehicle 2 but not installed in the vehicle 2, and includes AR glasses, VR headset, external display, gaming controller, speaker and vibration device. The gaming device 16 is connected to the in-vehicle device 12 and sends and receives information while playing games. The game device 16 may include a game console body and send and receive information to and from the vehicle control device 10. The game console itself may be a smartphone.

The in-vehicle device 12 has a game control unit 30, a display unit 32, a speaker 34, a steering unit 36, a pedal unit 38, and a microphone 40. The display 32 may be, for example, a display in a center console, a display in a passenger seat or rear seat, or an instrument panel, or a combination thereof. Display 32 and speaker 34 function as game output devices and output images and sounds received from game control unit 30. The game output device may further include at least one of the following: an air conditioning device, a seat vibration device, and a haptic pedal. The active stabilizer device 18 is also one of the game output devices.

The steering device 36, pedal device 38, and microphone 40 serve as game input devices. The steering device 36 sends the rudder angle and rudder angle speed to the game control unit 30. The pedal device 38 sends the amount of operation of the accelerator pedal and brake pedal to the game control unit 30, respectively. Microphone 40 detects sounds, including the voice of the occupants, and sends them to game control unit 30. The game input devices may be set according to the type of game, e.g., steering device 36 and pedal device 38 are used when running a game in which vehicles are raced.

The game control unit 30 holds a plurality of programs for games, generates play results in response to instructions from the game input devices, and sends them to the game output devices. The game control unit 30 also sends play information to the vehicle control device 10 indicating that the game is being executed. The game control unit 30 can communicate wirelessly with an external game server device and may send instruction information from the game input device to the server device and receive play results from the server device. The play results include images and sounds.

The play information may include information indicating whether or not play is taking place, information requesting the active stabilizer device 18 to be driven, and information regarding the amount of drive of the active stabilizer device 18. For example, the game control unit 30 may request that the active stabilizer device 18 be driven when a racing game or action game is being played, and request that the active stabilizer device 18 not be driven when a simulation game or puzzle game is being played. For example, the information regarding the amount of driving of the active stabilizer device 18 includes information indicating the movement of the vehicle in the game, including information indicating the vehicle's speed, steering angle, acceleration and collision.

The vehicle control device 10 has an acquire 22, a command generation unit 24, a decision unit 26, and a controller 28. The acquire 22 acquires play information for a game played using the in-vehicle device 12 or for a game played using the game device 16. In either case, the play information is generated by being executed by the occupants in the vehicle.

The determination unit 26 determines the mode to be set for the variable damping force absorber 20 based on the play information. Referring to the new drawings for the mode to be set on the variable damping force absorber 20.

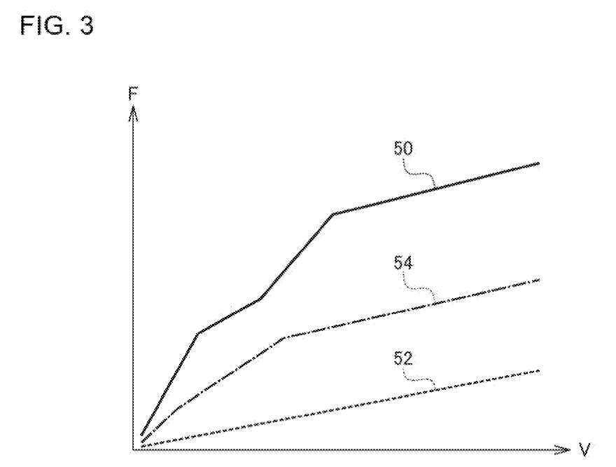

FIG. 3 illustrates the setting mode of the variable damping force absorber 20. The vertical axis of FIG. 3 shows the damping force F generated by the variable damping force absorber 20, and the horizontal axis shows the speed V of the piston of the variable damping force absorber 20. The speed V of the piston is the relative speed to the cylinder, and is the input to the damping force variable absorber 20.

In all of the first mode 50, second mode 52 and third mode 54, the damping force F increases as the speed V of the piston increases. The first mode 50 generates the greatest damping force F for the input. In the first mode 50, the opening of the connecting passage is the smallest, and in the second mode 52, the opening of the connecting passage is the largest.

The second mode 52 generates the smallest damping force F for the input. In the second mode 52, the damping force F generated in response to the input is smaller than in the first mode 50. The third mode 54 generates a damping force F between the first mode 50 and the second mode 52 for the input. The variable damping force absorber 20 is not limited to three setting modes, but may have two or four or more modes.

Return to FIG. 1. The decision unit 26 decides to set the variable damping force absorber 20 to the second mode 52 when the play information indicates that the game is being played and the active stabilizer device 18 is being driven. In other words, when the active stabilizer device 18 is driven and the vehicle body is to be shaken, the decision unit 26 can set the variable damping force absorber 20 to the softest mode, so that the vehicle body can be shaken responsively and significantly to bring a sense of reality of the game to the occupants.

When the play information indicates that the game is being played and the active stabilizer device 18 is not being driven, the decision unit 26 sets the variable damping force absorber 20 to the first mode 50. In other words, when the active stabilizer device 18 is not driven, the decision unit 26 sets the variable damping force absorber 20 to the hardest mode to make the vehicle body shake less. This reduces the vehicle shaking and poor game operability when the occupant operates the steering device 36 and pedal device 38 quickly and significantly. The decision section 26 sends the decision result to the control section 28.

The command generation section 24 generates command values to the active stabilizer device 18 so that the vehicle body is shaken in conjunction with the game play status based on the play information. For example, when playing a vehicle racing game, the command generator 24 tilts the actual vehicle body when the vehicle in the game turns, and when the vehicle in the game is rear-ended, the command generator 24 generates command values to make the actual vehicle body sway back and forth.

The controller 28 controls the active stabilizer device 18 and the variable damping force absorber 20 according to the command values of the command generation unit 24 and the decision results of the decision unit 26. The controller 28 may comprise a plurality of electronic control units (ECUs), including an ECU that controls the first active stabilizer device 18a, an ECU that controls the second active stabilizer device 18b, and an ECU that controls the variable damping force absorber 20.

When the play information indicates that a game is being played and the active stabilizer device 18 is being driven, the controller 28 sets the variable damping force absorber 20 to the second mode 52. This allows the vehicle body to sway easily and brings a sense of realism to the occupants in the game.

When the play information indicates that the game is being played and the active stabilizer device 18 is not driven, the controller 28 sets the variable damping force absorber to the first mode 50. This stabilizes the vehicle body and improves the operability of the game. Thus, the control unit 28 sets the variable damping force absorber 20 to either the first mode 50 or the second mode 52 according to the state of game play performed in the vehicle.

In the variant example, the decision unit 26 decides to set the first mode 50 if a game is being played in the vehicle, and the controller 28 sets the first mode 50 upon receiving the result of the decision. In other words, if the occupant is playing a game in the vehicle, the first mode 50 is set to stabilize the vehicle so that the vehicle body does not sway. On the other hand, if the occupant is not in a game in the vehicle while the vehicle is stopped, the decision unit 26 does not decide to drive the variable damping force absorber 20 because it does not receive any play information, and the controller 28 does not execute any special control for the variable damping force absorber 20.

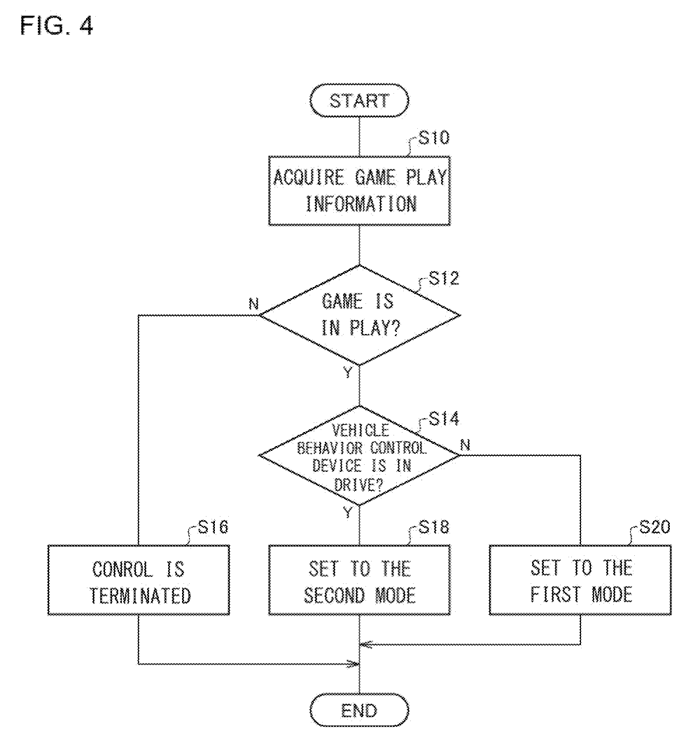

FIG. 4 is a flowchart of the example vehicle control method. The acquire 22 acquires game play information from the in-vehicle device 12 while the vehicle is stopped (S10). If the game is not in play, i.e., if the game is finished (S12), this control is terminated (S16). If the vehicle behavior control device is in drive (Y in S14), the decision unit 26 decides to set the variable damping force absorber 20 to the second mode 52, and the controller 28 widens the connecting passage of the variable damping force absorber 20 to the second mode 52 (S18).

If the vehicle behavior control system is not in drive (N in S14), the decision unit 26 decides to set the variable damping force absorber 20 to the first mode 50, and the controller 28 narrows the connecting passage of the variable damping force absorber 20 and sets it to the first mode 50 (S20).

The example is only an example, and it is understood by those skilled in the art that various variations in the combination of each component element are possible, and that such variations are also within the scope of the present disclosure invention.

In the example, an active stabilizer device 18 is shown as a vehicle behavior control device, but it is not limited to this form and can be an active suspension device or a combination of an active stabilizer device 18 and an active suspension device. The active suspension device may be an air suspension device or a full electric or hydraulic active suspension device. The active suspension device may also include a variable damping force absorber 20. The active suspension device can move the vehicle body in the roll direction by displacing one of the left and right wheel sides in the vertical direction, and can rock the vehicle body in the vertical direction by displacing both the left and right wheel sides in the vertical direction. In any case, the control unit 28 can control at least one of the active stabilizer device 18 and the variable damping force absorber 20 with the variable damping force absorber 20 set to the second mode 52, and can rock the vehicle body in the roll direction or the vertical direction, etc.

What is claimed is:

1. A vehicle control device comprising:
an acquirer that acquires play information of a game played by an occupant of a vehicle; and
a controller that controls a variable damping force absorber provided between a wheel and a vehicle body,
wherein the controller is capable of setting the variable damping force absorber to a first mode in which the magnitude of damping force generated in response to input is set, and to a second mode in which the damping force generated in response to the input is smaller than the first mode, and
wherein the controller sets the variable damping force absorber to one of the first mode and the second mode according to an acquired game playing state.

2. The vehicle control device according to claim 1,
wherein the controller sets the variable damping force absorber to the first mode when the play information indicates that a game is being played.

3. The vehicle control device according to claim 1,
wherein the controller iscapableof controlling a vehicle behavior control device capableof shaking the vehicle body, and
wherein the controller sets the variable damping force absorber to the second mode when the play information indicates that a game is being played and the vehicle behavior control device is driven.

4. The vehicle control device according to claim 3,
wherein the acquirer acquires play information of a game played using a vehicle-mounted device from the vehicle-mounted device.

5. A vehicle control method in which each step is performed by a vehicle control device mounted on a vehicle, the vehicle control method comprising:
acquiring play information of a game played by an occupant of the vehicle; and
controlling a variable damping force absorber provided between a wheel and a vehicle body;
wherein the variable damping force absorber is set to a first mode in which the magnitude of damping force generated in response to input is set, or to a second mode in which the damping force generated in response to the input is smaller than the first mode,
wherein in the controlling, the variable damping force absorber is set to one of the first mode and the second mode according to an acquired game playing state.
